(19) United States
(12) Patent Application Publication
(10) Pub. No.: US 2025/0219326 A1
(43) Pub. Date: Jul. 3, 2025

(54) CONNECTOR

(71) Applicant: BIZLINK INTERNATIONAL CORP., New Taipei City (TW)

(72) Inventors: Jui-Hung CHIEN, New Taipei City (TW); Chen-Wei YEH, New Taipei City (TW)

(21) Appl. No.: 19/002,727

(22) Filed: Dec. 27, 2024

(30) Foreign Application Priority Data
Dec. 28, 2023 (CN) 202311841828.5

(51) Int. Cl. H01R 13/633

(52) U.S. Cl. CPC H01R 13/6335

(57) ABSTRACT

A connector includes a base, a plugging element connected to the base, a cable module, a latch disposed on the base, and a strap assembly. The base includes rear and front ends. The front end exposes a portion of the plugging element. The cable module is electrically connected to the plugging element in the base and extends out of the base through the rear end. The strap assembly includes a connecting strap, a ring member, a first bonding layer, and first and second pull handles. The connecting strap is connected to the latch. The ring member is connected to the connecting strap. The first bonding layer is fixed to two portions of the ring member. The first and second pull handles are connected to the ring member. The first pull handle and the second pull handle are respectively located on opposite sides of the cable module.

### CROSS-REFERENCE TO RELATED APPLICATION

This application claims priority to China Application Serial Number 202311841828.5, filed Dec. 28, 2023, which is herein incorporated by reference.

### BACKGROUND

### Technical Field

The present disclosure relates to a connector, and more particularly, to a wire-end connector.

### Description of Related Art

A wire-end connector used to be connected to a server often includes a buckle. The buckle is used to engage the plug end of the wire-end connector with a board-end connector of the server. In order to facilitate the removal of the wire-end connector, the wire-end connector may be equipped with a pull handle to assist in pulling and is connected to the buckle. When the user pulls the pull handle, the buckle will separate from the board-end connector, making it easier to take out the wire-end connector.

However, when the server is disposed at a higher height or there are too many cables and the cables are too dense, the cables will be between the user and the pull handle. That is to say, due to the interference of the cables, it is difficult for the user to bypass the cables and conveniently apply force on the pull handle to separate the buckle and the board-end connector.

The above situation is becoming more and more serious as server machines become more and more complex and sophisticated. It not only causes inconvenience in server hardware maintenance and management, but also reduces the work efficiency of server operators.

Accordingly, how to provide a connector to solve the aforementioned problems becomes an important issue to be solved by those in the industry.

### SUMMARY

An aspect of the disclosure is to provide a connector that can efficiently solve the aforementioned problems.

In one embodiment of the present invention, an improvement for a strap assembly (or say, a pull tab) for a high-speed connector, such as MCIO, Multi-track, OSFP, or the like is disclosed. The strap assembly includes a connecting strap, a ring member, at least one bonding layer, and two pull handles.

The ring member is assembled by bonding one portion of the ring member to another portion using the bonding layer, thereby forming a loop-shaped structure. One side of the ring member connects to the latch on the connector base via the connecting strap, while the other side connects to two pull handles positioned on opposite sides of the cable module.

It is emphasized that the ring member is assembled rather than formed in one piece by molding, providing greater flexibility during installation. This design allows users to pull the handles from either side of the cable module, ensuring smooth separation of the plugging element from a board-end connector without interference from the cable module.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a connector according to an embodiment of the present disclosure;

FIG. 2 is an exploded view of the connector in FIG. 1;

FIG. 3 is a cross-sectional view of the connector in FIG. 1;

FIG. 4 is another cross-sectional view of the connector in FIG. 1;

FIG. 5 is a perspective view of a connector according to another embodiment of the present disclosure;

FIG. 6 is an exploded view of the connector in FIG. 5;

FIG. 7 is an exploded view of the connector in FIG. 5; and

FIG. 8 is an exploded view of the connector in FIG. 5.

### DETAILED DESCRIPTION

The following disclosure will now be described more fully herein by drawings and references, in which some exemplary embodiments are shown. The present disclosure may be implemented in different forms and should not be limited by the embodiments mentioned below. However, these embodiments are provided to facilitate a more complete understanding of the disclosure and to fully convey the scope of the disclosure to those skilled in the art. The same reference numbers will be used throughout the text to refer to similar elements.

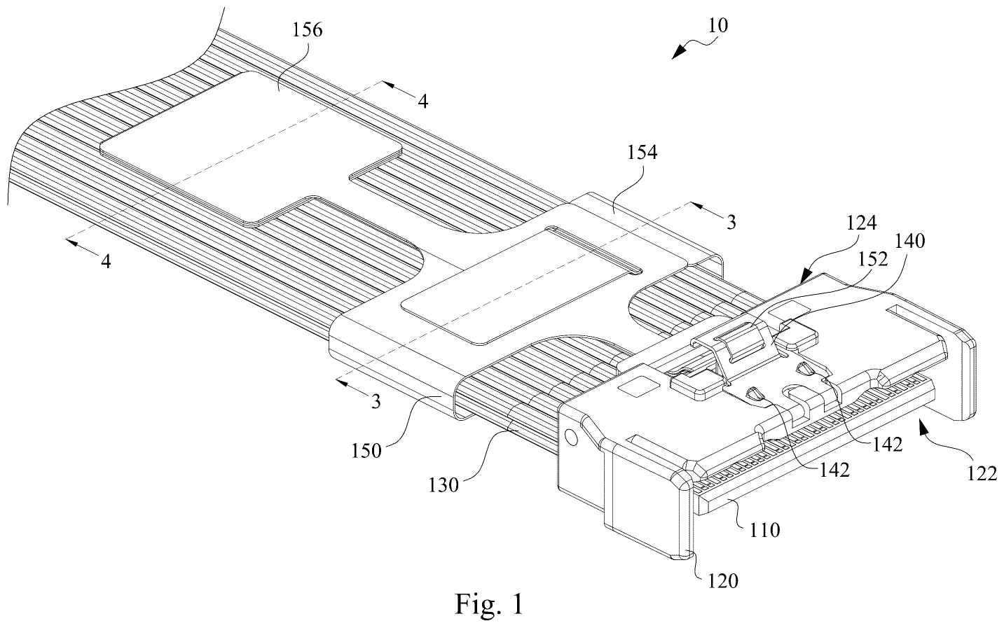

In addition, FIGS. 1 to 7 are drawn to true scale. In order to keep the description concise, the proportions of each component are not listed one by one. However, the proportions and positions of each component shall be regarded as part of the contents of the present disclosure.

Reference is made to FIGS. 1 to 7. The present disclosure provides embodiments of one or more connectors, which may be applied in the field of server connection, for example. For example, in some embodiments, the connector of the present disclosure may be connected between servers. In other embodiments, a wire-end connector of the present disclosure can be used to connect multiple components in a server.

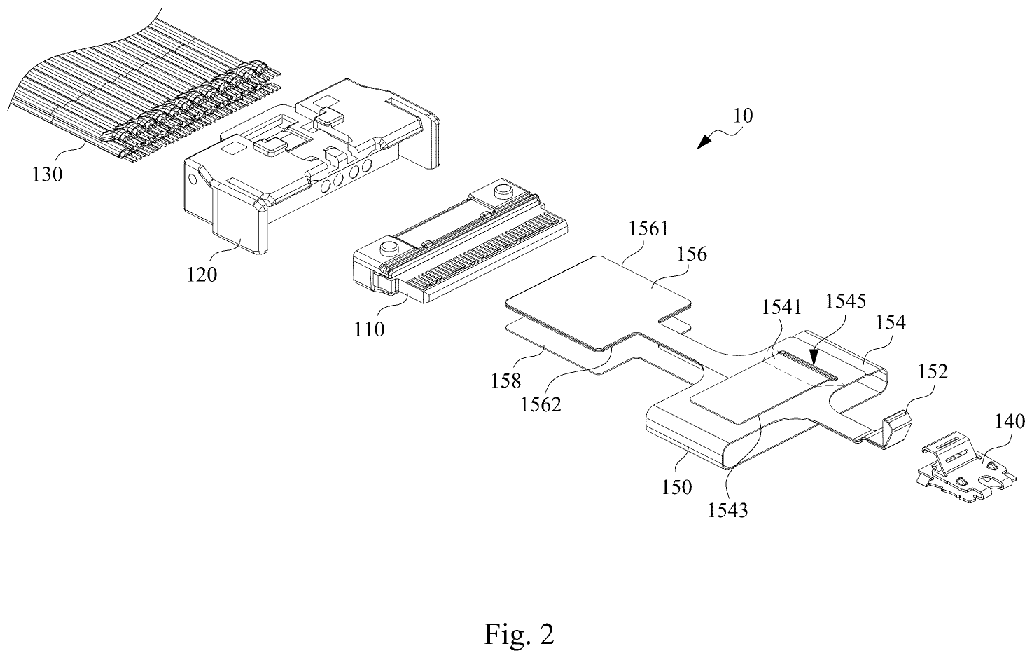

Please refer to FIG. 1 and FIG. 2 at the same time. FIG. 1 is a perspective view of a connector 10 according to an embodiment of the present disclosure. FIG. 2 is an exploded view of the connector 10 in FIG. 1. In the present embodiment, the connector 10 is a cable assembly that complies with the MCIO connector specification, but is not limited thereto. In another example, the connector can be a cable assembly that complies with the NEATSTACK connector specification.

The connector 10 includes a plugging element 110, a base 1210, cable modules 130, a latch 140, and a strap assembly 150.

In the present embodiment, the plugging element 110 is a printed circuit board (PCB) containing an internal mold package, but is not limited thereto. When necessary, the plugging element 110 may also refer to components such as metal terminals and cables that can be used for signal and energy transmission. After the cable modules 130 are soldered to the soldering pads of the PCB of the plugging element 110, an inner mold layer may be formed on the outside. The base 120 may be then formed on the outside by injection molding.

The base 120 includes a front end 122 (front opening) and a rear end 124 (rear opening). The front end 122 exposes a portion of the plugging element 110. The connector 10 transmits signals or energy by inserting the plugging element 110 into another connector (not shown).

The cable modules 130 are electrically connected to the plugging element 110 in the base 120. The cable modules 130 extend out of the base 120 through the rear end 124. The cable modules 130 extend in a direction away from base 120.

The latch 140 is fixed on an upper surface of the base 120 through a fixing mechanism or adhesive. The latch 140 includes a plurality of hooks 142. The hooks 142 are disposed on a side of the latch 140 away from the base 120. The hooks 142 are configured to engage another connector. A plurality of through holes may be formed on the latch 140.

The strap assembly 150 is configured for a user to pull to move the latch 140. In more detail, the strap assembly 150 may be connected to each of the through holes of the latch 140 in a looping manner. When the user pulls the strap assembly 150, the hooks 142 are configured to deform and displace relative to the base 120 toward the base 120 to disengage from another connector engaged therewith.

Please continue to refer to FIG. 2. In the present embodiment, the strap assembly 150 provides pull handles for the user to hold on two opposite wide surfaces/sides of the cable modules 130. Accordingly, no matter which side of the cable modules 130 the user's hand is on, the user can easily reach at least one of a first pull handle 156 and a second pull handle 158. In other words, the connector 10 can be separated from another connector (not shown) more conveniently.

In the present embodiment, the strap assembly 150 is composed of a single integrated polymer sheet that is folded and combined with various adhesive and pasting materials. More specifically, the strap assembly 150 includes a connecting strap 152, a ring member 154, the first pull handle 156, and the second pull handle 158.

The first pull handle 156 and the second pull handle 158 respectively extend from upper and lower edges behind the ring member 154 toward the rear or away from the base 120. The connecting strap 152 extends from the upper or lower edge in front of the ring member 154 toward the front or toward the base 120. In this way, the first pull handle 156 and the second pull handle 158 can drive the connecting strap 152 through the ring member 154 to move the latch 140. At the same time, the ring member 154 forms a closed loop and surrounds the cable modules 130.

In some embodiments, the connecting strap 152, the ring member 154, the first pull handle 156, and the second pull handle 158 of the strap assembly 150 are a one-piece formed structure. In other words, the connecting strap 152, the ring member 154, the first pull handle 156, and the second pull handle 158 of the strap assembly 150 are portions of a unitary structure respectively. However, when necessary, the above-mentioned portion may be connected by independent components.

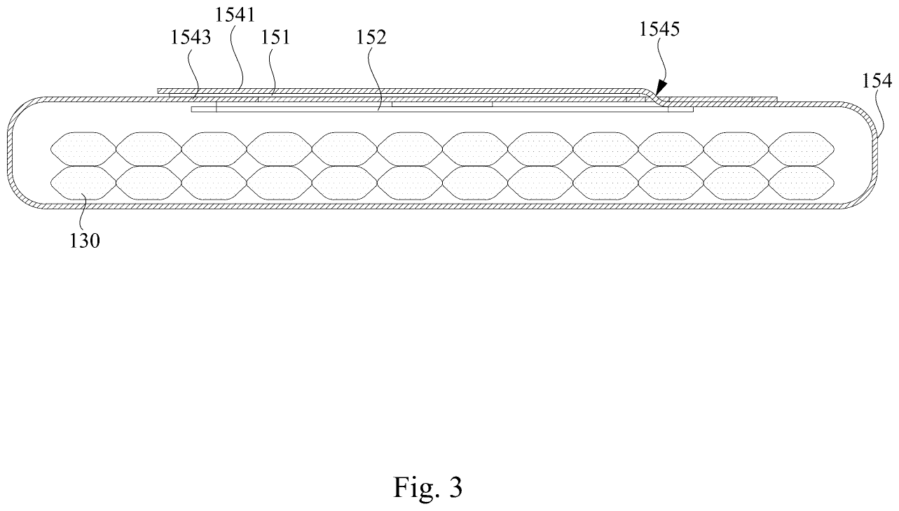

Reference is made to FIG. 2 and FIG. 3. FIG. 3 is a cross-sectional view of the connector 10 taken along line 3-3 in FIG. 1.

The ring member 154 includes a narrow end portion 1541, a bonding portion 1543, and a strap opening 1545. The narrow end portion 1541 is located at a distal end of the ring member 154.

The strap assembly 150 further includes a first bonding layer 151. The first bonding layer 151 may be disposed on the bonding portion 1543. In the present embodiment, the bonding portion 1543 is located at the strap opening 1545 or an inner side of the narrow end portion 1541. The narrow end portion 1541 passes through the strap opening 1545. The narrow end portion 1541 is adhered to the bonding portion 1543 through the first bonding layer 151. In other words, the first bonding layer 151 is fixed to two portions of the ring member 154 (the narrow end portion 1541 and the bonding portion 1543) to form a closed loop of the ring member 154. The ring member 154 includes more than two layers of plates at the joint of the first bonding layer 151, which can provide the ring member 154 with better toughness and is less likely to break. In another embodiment, the first bonding layer 151 may be optionally omitted and replaced by an anti-exit structure which includes hook-shaped structures provided on the left and right sides of the narrow end portion 1541 respectively. That is, the T-shaped outline shown by the dotted line in FIG. 2 is an example. In this way, the narrow end portion 1541 can be prevented from exiting the strap opening 1545 by the anti-exit structure, thereby maintaining the shape of the ring member 154.

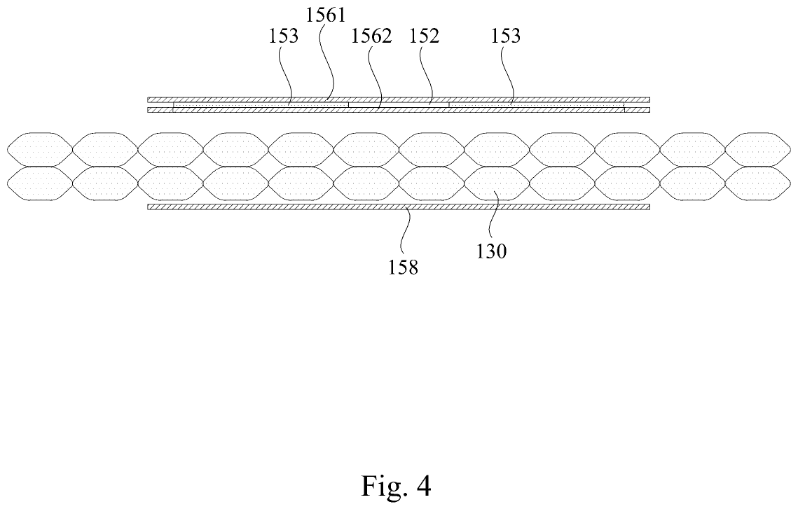

Please refer to FIG. 2 and FIG. 4 at the same time. FIG. 4 is another cross-sectional view of the connector 10 taken along line 4-4 in FIG. 1. In the present embodiment, the strap assembly 150 further includes a second bonding layer 153. The first pull handle 156 includes a middle portion 1561 and a second portion 1562. The middle portion 1561 is connected to the ring member 154. The second portion 1562 is connected to the middle portion 1561. The second portion 1562 is bent relative to the middle portion 1561. The second bonding layer 153 is adhered between the middle portion 1561 and the second portion 1562. In this way, the first pull handle 156 includes more than two layers of plates at the adhering place of the second bonding layer 153, which can provide the first pull handle 156 with better toughness and is less likely to break.

Please continue to refer to FIG. 2, FIG. 3, and FIG. 4. In the present embodiment, an end of the connecting strap 152 is connected to the ring member 154. The other end of the connecting strap 152 passes through the ring member 154 (see FIG. 3) and extends between the middle portion 1561 and the second portion 1562. The end of the connecting strap 152 extending between the middle portion 1561 and the second portion 1562 connects the middle portion 1561 and the second portion 1562 through the second bonding layer 153.

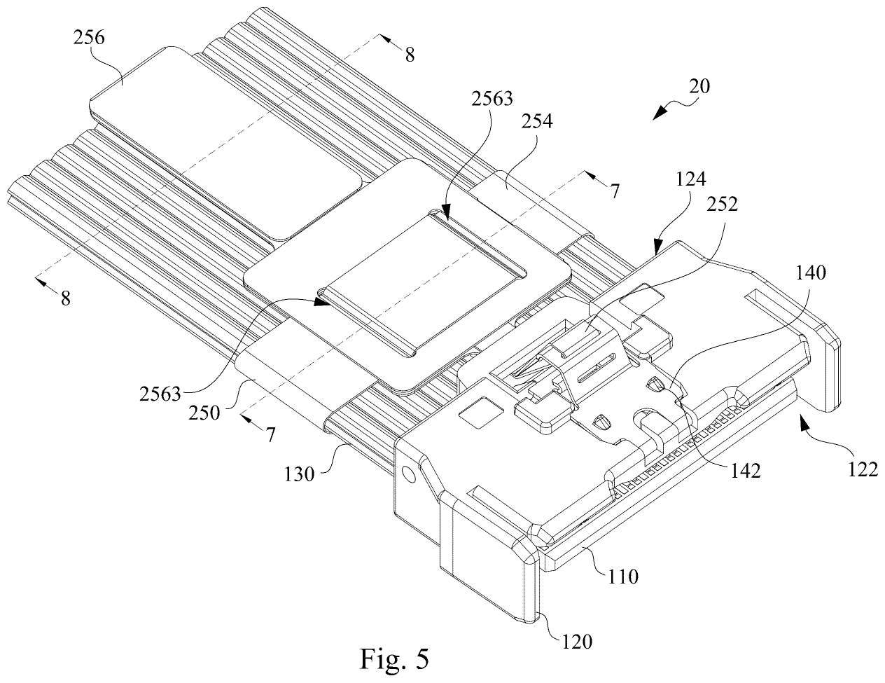

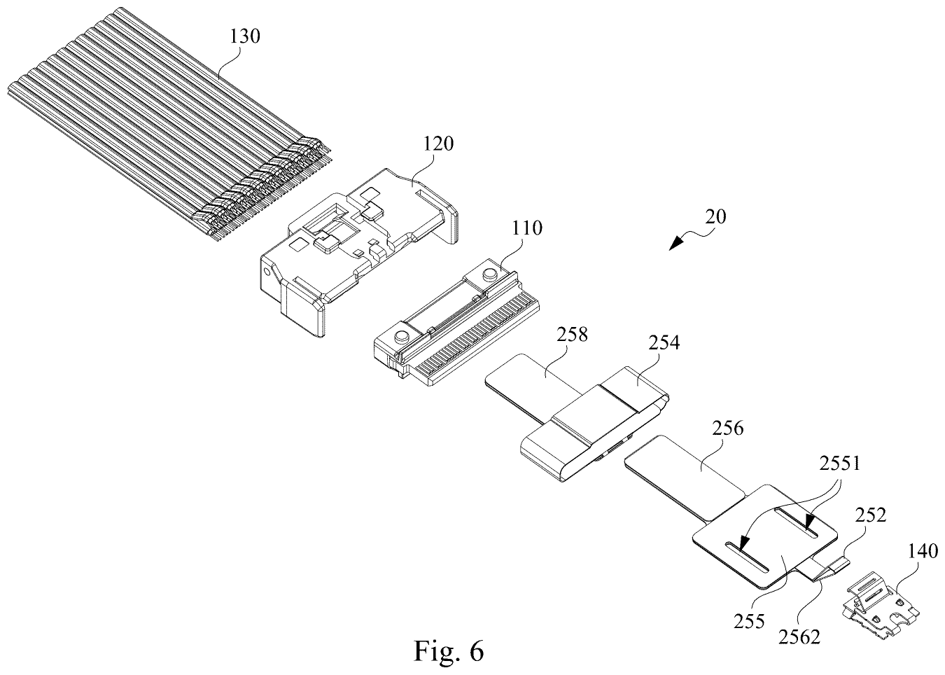

Reference is made to FIG. 5 and FIG. 6. FIG. 5 is a perspective view of a connector 20 according to another embodiment of the present disclosure. FIG. 6 is an exploded view of the connector 20 in FIG. 5. In some embodiments, the difference between the connector 20 in FIG. 5 and the connector 10 in FIG. 1 is that the body of the strap assembly 150 of the connector 10 is mainly composed of a single component, while the strap assembly 250 of the connector 20 is composed of multiple components.

Please continue to refer to FIG. 6. Specifically, the strap assembly 250 of the connector 20 includes a first component set and a second component set. The first component set includes a connecting strap 252, a middle portion 255, and a first pull handle 256. The second component set includes a ring member 254 and a second pull handle 258.

The middle portion 255 includes two strip-shaped through holes 2551. The ring member 254 passes through the two strip-shaped through holes 2551 to fix the ring member 254 to the middle portion 255. Apart from this, the rest of the design is basically the same as in FIG. 2 and will not be described again.

Based on the above, the connecting strap 252 and the first pull handle 256 are two portions of a unitary structure respectively. The ring member 254 and the second pull handle 258 are two portions of another unitary structure respectively.

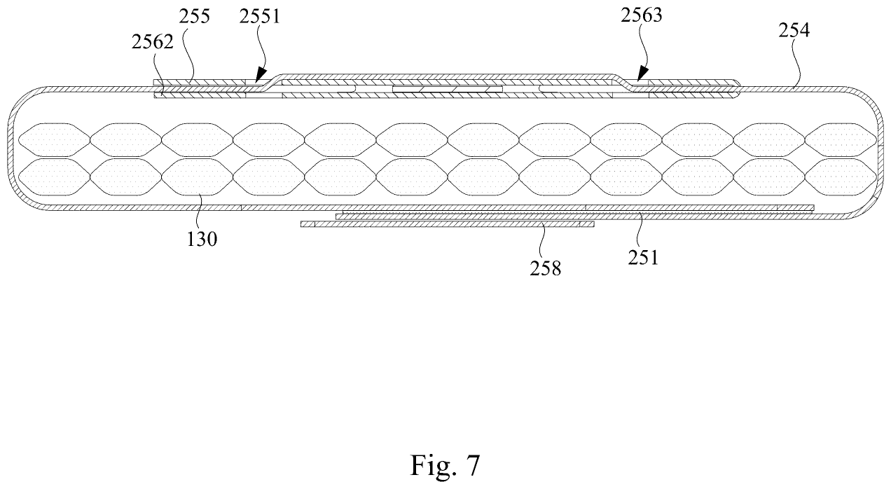

Reference is made to FIG. 7. FIG. 7 is an exploded view of the connector 20 taken along line 7-7 in FIG. 5. In the present embodiments, the middle portion 255 and the second portion 2562 extend in a direction away from the connecting strap 252. The two strip-shaped through holes 2551 penetrate at least the middle portion 255.

Please continue to refer to FIG. 7. In the present embodiment, the strap assembly 250 further includes a first bonding layer 251. The first bonding layer 251 is bonded to two portions respectively located at both ends of the ring member 254. The first bonding layer 251 is located on a wide surface side of the cable modules 130.

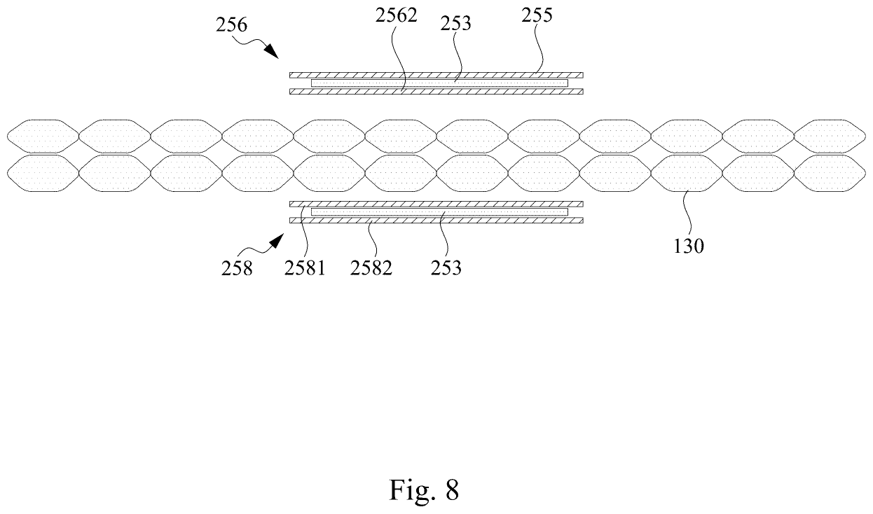

Reference is made to FIG. 8. FIG. 8 is an exploded view of the connector 20 taken along line 8-8 in FIG. 5. In some embodiments, the strap assembly 250 further includes one or more second bonding layers 253. The second bonding layers 253 are bonded between the middle portion 255 and the second portion 2562 of the first pull handle 256.

Please continue to refer to FIG. 6 and FIG. 8. In some embodiments, the second pull handle 258 includes a third portion 2581 and a fourth portion 2582. The third portion 2581 and the fourth portion 2582 extend in a direction away from the ring member 254. The second bonding layers 253 are bonded between the third portion 2581 and the fourth portion 2582.

In some embodiments, the strap assemblies 150 and 250 may each be formed by folding plastic sheets.

In some embodiments, the first bonding layers 151 and 251 and the second bonding layers 153 and 253 can be quick-drying glue, double-sided tapes, Velcro tapes, or other materials or means suitable for fixing the surfaces of two objects to each other. In addition, the thicknesses and areas of the first bonding layers 151 and 251 and the second bonding layers 153 and 253 can be adjusted according to actual needs. The present disclosure is not intended to limit the exact compositions, locations, and thicknesses of the first bonding layers 151, 251 and the second bonding layers 153, 253.

According to the foregoing recitations of the embodiments of the disclosure, it can be seen that since the first pull handle and the second pull handle of the connector of the present disclosure are located on opposite sides of the cable module, the user can easily pull the strap assembly to disengage the connector without interference from the cable module. In addition, the strap component of the present disclosure can be a unitary structure, and the strength can be further increased by adhering multiple layers of plates with the bonding layers, which can achieve the advantageous effects of being easy to manufacture and strong and sturdy.

Although the present disclosure has been described in considerable detail with reference to certain embodiments thereof, other embodiments are possible.

Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector, comprising:
a base;
a plugging element, a portion of the plugging element being disposed in the base, while another portion of the plugging element being exposed at a front end of the base;
a cable module electrically connected to the plugging element in the base and extending out of the base through a rear end of the base;
a latch disposed on the base; and
a strap assembly comprising:
a ring member;
a connecting strap extending from the ring member toward the latch and connected therewith;
a first bonding layer fixing a portion of the ring member to another portion of the ring member so as to form a loop-shaped structure;
a first pull handle connected to the ring member and extending away from the ring member; and
a second pull handle connected to the ring member and extending away from the ring member, the first pull handle and the second pull handle are respectively located on opposite sides of the cable module.

2. The connector of claim 1, wherein the ring member surrounds the cable module.

3. The connector of claim 1, wherein the connecting strap, the ring member, the first pull handle, and the second pull handle are portions of a unitary structure respectively.

4. The connector of claim 1, wherein the ring member comprises a narrow end portion, a bonding portion, and a strap opening, the narrow end portion passes through the strap opening, and the first bonding layer is adhered between the narrow end portion and the bonding portion.

5. The connector of claim 4, wherein the first bonding layer is located on a wide surface side of the cable module.

6. The connector of claim 1, wherein the strap assembly further comprises a second bonding layer, at least one of the first pull handle and the second pull handle comprises a middle portion and a second portion, the middle portion is connected to the ring member, the second portion is connected to the middle portion, the second portion is bent relative to the middle portion, the second bonding layer is adhered between the middle portion and the second portion, and the connecting strap is partially located between the middle portion and the second portion.

7. The connector of claim 1, wherein the first pull handle comprises a middle portion and a second portion, the middle portion and the second portion are directly connected to the connecting strap, and the middle portion is connected to the second portion.

8. The connector of claim 1, wherein the first pull handle is connected to the connecting strap, the first pull handle comprises two strip-shaped through holes, and the ring member passes through the two strip-shaped through holes.

9. The connector of claim 1, wherein the connecting strap and the first pull handle are two portions of a unitary structure respectively, and the ring member and the second pull handle are two portions of another unitary structure respectively.

10. The connector of claim 9, wherein the first pull handle comprises a middle portion and a second portion, the middle portion is connected to the ring member, the second portion is connected to the middle portion, the second pull handle comprises a third portion and a fourth portion connected to the third portion, and the third portion and the fourth portion extend in a direction away from the ring member.

11. The connector of claim 1, wherein the latch has a plurality of through holes, and the strap assembly is connected to each of the through holes.

12. The connector of claim 1, wherein the latch comprises a plurality of hooks disposed on a side of the latch away from the base.

13. A connector, comprising:
a base comprising a rear end and a front end;
a plugging element connected to the base, wherein the front end exposes a portion of the plugging element;
a cable module electrically connected to the plugging element in the base and extending out of the base through the rear end;
a latch disposed on the base; and
a strap assembly comprising:
a connecting strap connected to the latch;
a ring member connected to the connecting strap, wherein the ring member comprises a narrow end portion and a strap opening, the narrow end portion passes through the strap opening, the narrow end portion is provided with an anti-exit structure, and the anti-exit structure is used to prevent the narrow end portion from exiting the strap opening;
a first pull handle connected to the ring member; and
a second pull handle connected to the ring member, wherein the first pull handle and the second pull handle are respectively located on opposite sides of the cable module.

14. The connector of claim 13, wherein the anti-exit structure comprises hook-shaped structures provided on opposite sides of the narrow end portion respectively.

15. The connector of claim 14, wherein the anti-exit structure and the narrow end portion form a T-shaped outline.
